(19) United States
(12) Patent Application Publication
(10) Pub. No.: US 2010/0170666 A1
(43) Pub. Date: Jul. 8, 2010

(54) Heat Exchanger and Method of Making and Using the Same

(75) Inventors: James Allen Zess, Vancouver, WA (US); Andrew Schlote, Fenton, MO (US)

Correspondence Address: THOMPSON COBURN LLP, ONE US BANK PLAZA, SUITE 3500, ST LOUIS, MO, 63101, US

(73) Assignee: ZESS INC., Vancouver, WA (US)

(21) Appl. No.: 12/349,794

(22) Filed: Jan. 7, 2009

(51) Int. Cl. F28D 7/00; B23P 15/26

(52) U.S. Cl. 165/164; 29/890.054

(57) ABSTRACT

A method of transferring heat from a warmer stream of gas to a cooler stream of gas comprises flowing the warmer stream of gas through a heat exchanger in a manner such that the warmer stream of gas converges as the warmer stream of gas flows through the heat exchanger. The method further comprises flowing the cooler stream of gas through the heat exchanger in a manner such that the cooler stream of gas diverges as the cooler stream of gas flows through the heat exchanger. Another method comprises forming a heat exchanger by solid state welding a plurality of laminate members to each other. The heat exchanger may be a heatsink. The heat exchanger may also condense gas into a liquid.

### CROSS-REFERENCE TO RELATED APPLICATIONS

None.

### STATEMENT REGARDING FEDERALLY SPONSORED RESEARCH OR DEVELOPMENT

Not Applicable.

### APPENDIX

Not Applicable.

### BACKGROUND OF THE INVENTION

1. Field of the Invention

This invention pertains to heat exchangers. More particularly, the present invention pertains to heat exchangers that are ideally suited for transferring heat between two gaseous fluids.

2. General Background

Heat exchangers are used in numerous industries and devices for numerous purposes. Many types of heat exchangers rely on the transfer of heat between two fluids. For example, many internal-combustion engines are typically water cooled and typically utilize a heat exchanger (radiator) to transfer heat from the liquid water or coolant to air. Some heat exchangers are gas-to-gas heat exchangers, wherein heat is transferred between two separate streams of gaseous fluid. The steady-state efficiency of a gas-to-gas heat exchanger is typically dependent upon the amount of surface area of the heat exchanger that contacts each of the fluid streams and the thermal conductivity of the material that separates the two fluid streams. Thus, it is advantageous to maximize the surface area of the heat exchanger that separates the fluid streams, while also minimizing the amount of material that separates the fluid streams. However, increasing the surface area to volume ratio of a heat exchanger can greatly complicate the fabrication or the size of heat exchangers, and therefore the cost and/or space required.

Another thing impacting the amount of heat transferred by a heat exchanger is the differences in the temperatures of the fluid streams as they pass through the heat exchanger. It is known that by flowing the streams of fluid in opposite directions through a heat exchanger, the temperature differential of the fluid streams can be kept more uniform throughout the heat exchanger. Such “counter-flow” heat exchangers typically operate with a higher efficiency than heat exchangers wherein the streams flow in the same direction along opposite surfaces of the walls of the heat exchanger and with a higher efficiency than cross-flow heat exchangers.

Unlike liquid fluids, gaseous fluids are easily compressed. As such, the temperature of fluids in a gas state can be altered by expanding or compressing such fluids. Likewise, as heat is removed from a gaseous fluid under constant pressure, the volume occupied by the fluid decreases. Thus, as a gaseous fluid stream of constant cross-sectional area passes through a heat exchanger and loses heat, the flow velocity normally decreases as the gaseous fluid passes through the heat exchanger as a result of the volume decrease.

### SUMMARY OF THE INVENTION

The present invention provides several advantages over prior art heat exchangers. One such advantage is that the invention allows for a relatively simplistic method of fabricating a highly efficient heat exchanger. The preferred embodiment of the present invention is configured such that the cross-sectional area of the stream of fluid being cooled decreases as said stream passes through the heat exchanger and, conversely, the cross-sectional area of the stream of fluid being heated increases as said stream passes through the heat exchanger. Assuming the fluid stream being cooled is gaseous, the reduction of the cross-sectional area of said fluid stream has the effect of decreasing the volume of said fluid stream which minimizes the reduction of the temperature of said fluid stream as said fluid stream passes through the heat exchanger. Likewise, assuming the fluid stream being heated is gaseous, the increases of the cross-sectional area of said fluid stream has the effect of increasing the volume of said fluid stream which minimizes the increase of the temperature of said fluid stream as said fluid stream passes through the heat exchanger. This is advantageous in that it maximizes the temperature differential between the fluid streams as they pass through the heat exchanger and therefore increases the overall amount of heat exchanged between the fluid streams.

In one aspect of the invention, a method of transferring heat from a warmer stream of gas to a cooler stream of gas comprises flowing the warmer stream of gas through a heat exchanger in a manner such that the warmer stream of gas converges as the warmer stream of gas flows through the heat exchanger and in a manner such that the warmer stream of gas is at least partially bound by a wall of the heat exchanger. The method further comprises flowing the cooler stream of gas through the heat exchanger in a manner such that the cooler stream of gas diverges as the cooler stream of gas flows through the heat exchanger and in a manner such that the cooler stream of gas is at least partially bound by the wall of the heat exchanger. Still further, the method comprises allowing heat to conduct through the wall from the warmer stream of gas to the cooler stream of gas.

In another aspect of the invention, a heat exchanger extends at least partially around and along a central axis (the central axis defining axial and radial directions). The heat exchanger at least partially encircles an interior fluid containing region and is at least partial encircled by an exterior fluid containing region. The heat exchanger comprises a plurality of arcuate fluid passageways alternating in the axial direction with a plurality of arcuate fluid cavities. Each of the arcuate fluid passageways extends radially through the heat exchanger and creates a fluid connection between the interior and exterior fluid containing regions. The heat exchanger also comprises first and second axially extending fluid passageways that traverse each of the arcuate fluid passageways and that are in fluid communication with each of the arcuate fluid cavities in a manner connecting the arcuate fluid cavities in parallel. The first axially extending fluid passageway is a first radial distance from the central axis and the second axially extending fluid passageway is a second radial distance from the central axis. The second radial distance is greater than the first radial distance.

In yet another aspect of the invention, a method of fabricating a heat exchanger comprises solid state welding a plurality of substantially identical first laminate members to a plurality of substantially identical second laminate members in a manner creating a bonded stack of the first and second laminate members comprised of alternating first and second laminate members. Each of the first laminate members comprises a bottom surface, a top surface, at least two pass-through passageways, and at least one recess. The recess of each of the plurality first laminate members extends down into such first laminate member from the top surface and extends from an edge of such first laminate member to an opposite edge of such first laminate member. Each of the pass-through passageways extends through such first laminate member from the top surface to the bottom surface of such first laminate member. Each of the second laminate members comprises a bottom surface, a top surface, at least two openings, and at least one recess. The recess of each of the second laminate members extends down into such second laminate member from the top surface of such second laminate member. Each of the openings of each of the second laminate members extends from the bottom surface and opens into the recess of such second laminate member in a manner such that said recess operatively joins said openings. Each of the pass-through passageways of each of the first laminate members operative connects at least one of the openings of an adjacent one of the second laminate members to the recess of another adjacent one of the second laminate members.

Further features and advantages of the present invention, as well as the operation of various embodiments of the present invention, are described in detail below with reference to the accompanying drawings.

### BRIEF DESCRIPTION OF THE DRAWINGS

FIG. 1 is a perspective view of one embodiment of a heat exchanger in accordance with the invention.

FIG. 2 is another perspective view of the heat exchanger shown in FIG. 1, showing the opposite axial end of the heat exchanger.

FIG. 3 is a perspective view of the upper end plate of one of the subassemblies of the heat exchanger shown in FIGS. 1 and 2, as viewed from above.

FIG. 4 is a perspective view of the lower end plate of the subassembly of the heat exchanger shown in FIGS. 1 and 2, as viewed from below.

FIG. 5 is perspective view of one of a plurality of similar laminate members that forms part of the subassembly of the heat exchanger shown in FIGS. 1 and 2, as viewed from above.

FIG. 6 is perspective view of one of another plurality of similar laminate members that form the subassembly of the heat exchanger shown in FIGS. 1 and 2, as viewed from above.

FIG. 7 is a detail view of the laminate member shown in FIG. 5, as indicated in FIG. 5.

FIG. 8 is a detail view of the laminate member shown in FIG. 6, as indicated in FIG. 6.

FIG. 9 is a cross-sectional view of an assembly comprising the heat exchanger shown in FIGS. 1-8.

FIG. 10 is a front elevation view of a heatsink in accordance with the invention.

FIG. 11 is a side elevation view of the heatsink shown in FIG. 10.

FIG. 12 is a perspective view of a laminate of the heatsink shown in FIGS. 10 and 11.

FIG. 13 is a perspective view of a plurality of laminates formed together during part of the preferred method of assembling the heatsink shown in FIGS. 10 and 11.

Reference numerals in the written specification and in the drawing figures indicate corresponding items.

### DETAILED DESCRIPTION OF THE PREFERRED EMBODIMENTS

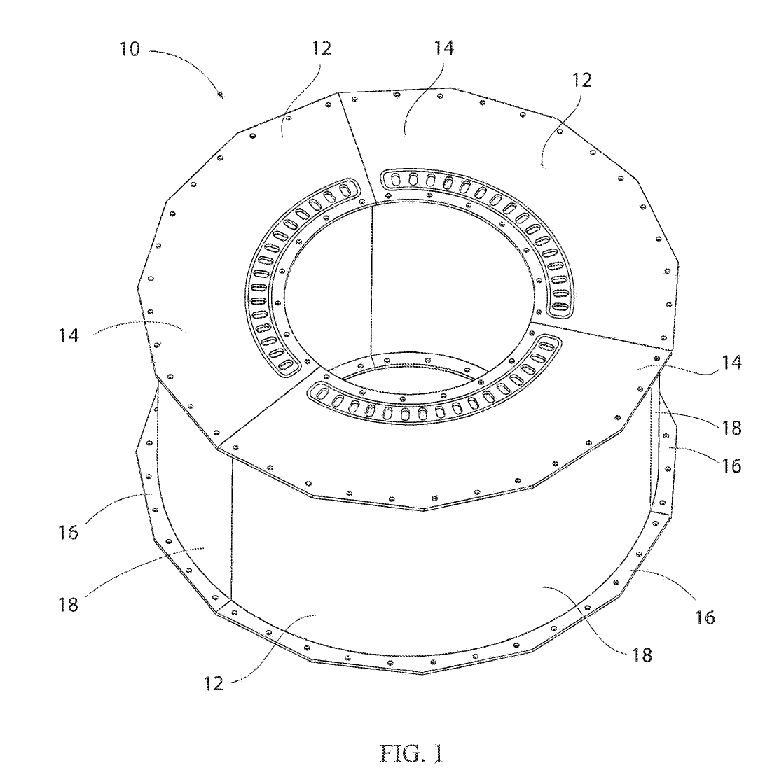

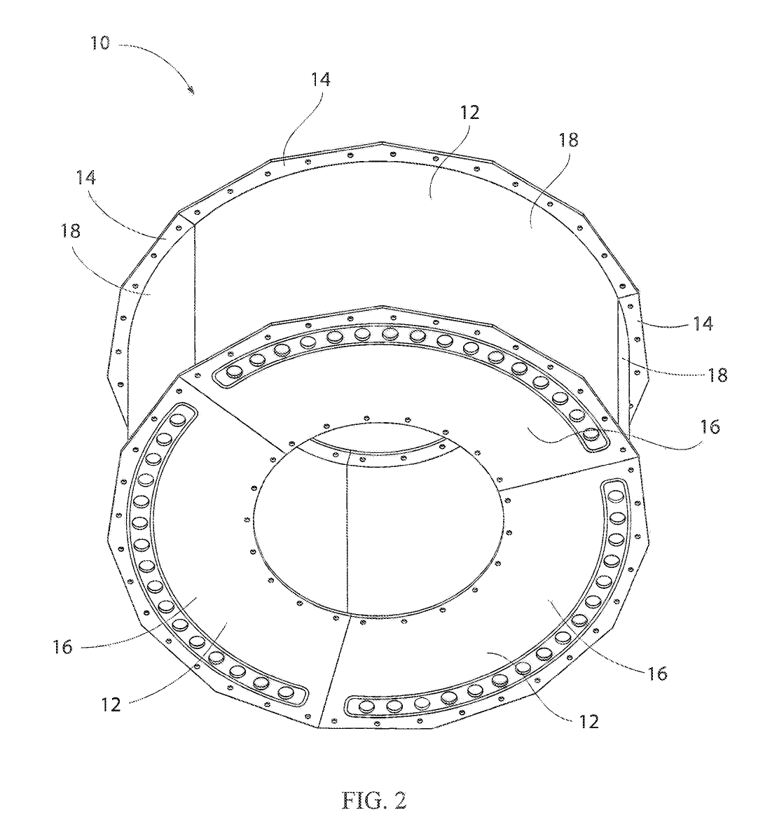

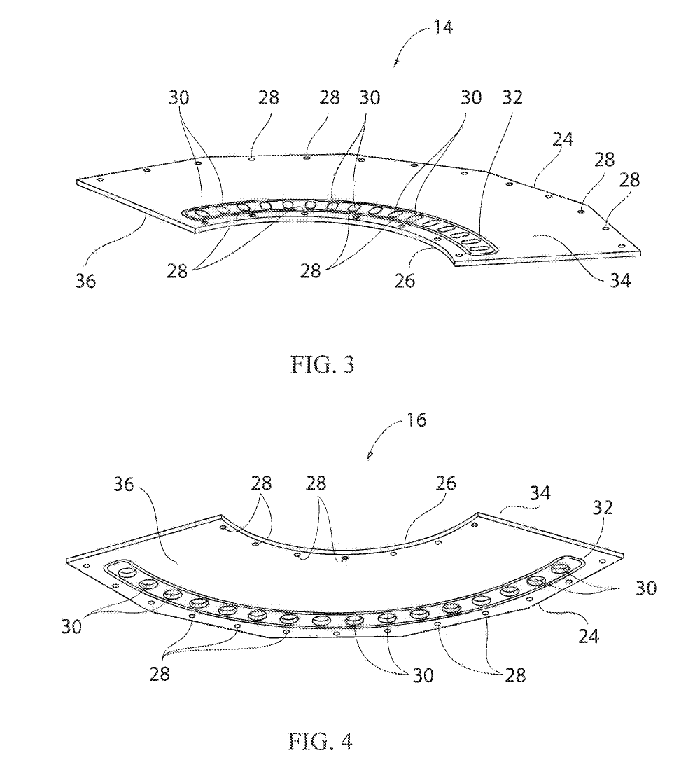

A heat exchanger in accordance with the present invention is shown in FIGS. 1 and 2. The heat exchanger 10 preferably comprises three identical arcuate subassemblies 12 that together form and annular ring. Each of the subassemblies 12 is capable of operating as a heat exchanger independently of the other subassemblies, but preferably acts in concert with the other subassemblies. For purposes of describing the invention, it should be appreciated that the annular ring defines an axial direction (i.e., any direction parallel to the center axis of the ring), a radial direction (any direction away or toward the center axis), and a circumferential direction (any curvilinear direction that revolves about the center axis). Additionally, the heat exchanger 10 and its components are referred to as having upper/top and lower/bottom elements. It should be appreciated that such adjectives are used merely to explain the orientation of the various elements relative to each other and not relative to the direction of gravity.

Each of the sub assemblies 12 preferably comprises an upper 14 end plate, a lower end plate 16, and a stack 18 of alternating first laminate members 20 and second laminate members 22. As discussed in greater detail below, these components are preferably formed of metal and are preferably diffusion bonded to each other (also referred to as diffusion welded).

The upper end plate 14 preferably has a polygonal arcuate outer edge 24 and a smooth arcuate inner edge 26. A plurality of mounting holes 28 are circumferential spaced along the inner edge 26 and the outer edge 24 and extend through the upper end plate 14. A plurality of oval fluid passageway openings 30 also extend through the upper end plate 14 and are circumferentially spaced adjacent the mounting holes 28 nearest the inner edge 26. A gasket groove 32 having a semicircular cross-section extends down into the upper end plate 14 from the top surface 34 of the upper end plate and encircles the fluid passageway openings 30. The bottom surface 36 of the upper end plate 14 is preferably a contiguous planar surface.

The lower end plate 16 is similar to the upper end plate and preferably comprises a polygonal arcuate outer edge 24, a smooth arcuate inner edge 26, a plurality of mounting holes 28 that are identical to those of the upper end plate 14. However, the fluid passageway openings 30 that extend through the lower end plate 16 are circumferentially spaced adjacent the mounting holes 28 nearest the outer edge 26 of the lower end plate and are preferably circular rather than oval. The total cross-sectional area of all the fluid passageway openings 30 of the lower end plate 16 is preferably appreciably greater than the total cross-sectional area of all of the fluid passageway openings of the upper end plate 14. Similar to the upper end plate 14, a gasket groove 32 having a semicircular cross-section extends upward into the lower end plate 16 from the bottom surface 36 of the lower end plate and encircles the fluid passageway openings 30. The top surface 34 of the lower end plate 16 is preferably a contiguous planar surface.

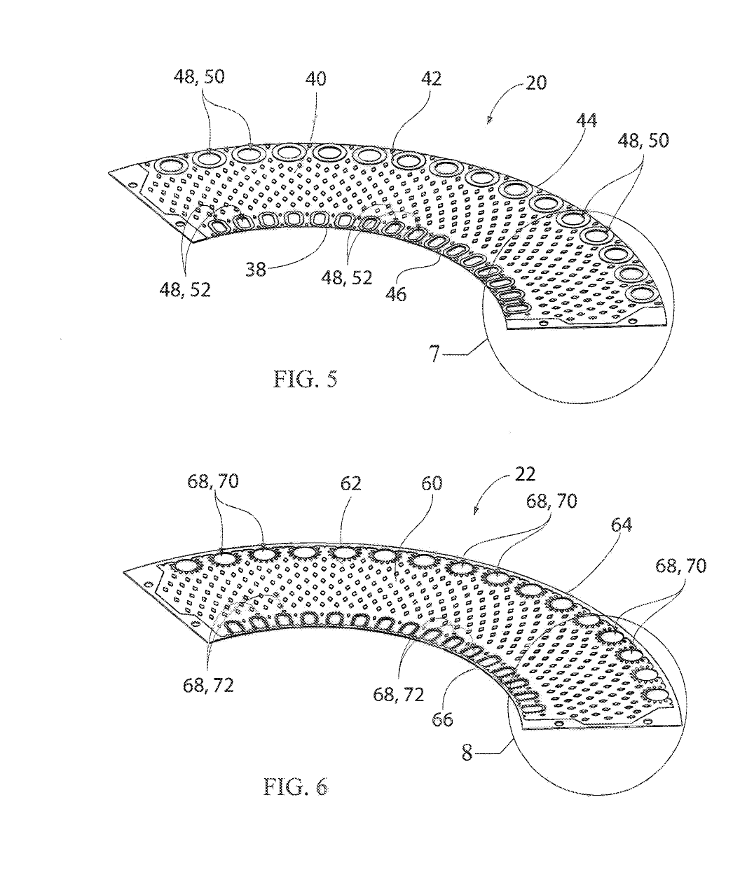

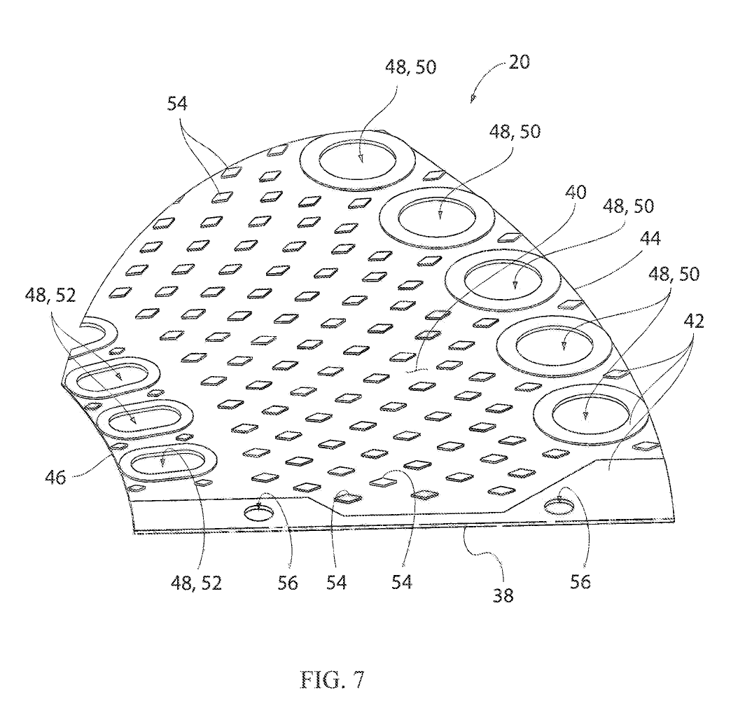

As mentioned above, the stack 18 laminate members comprises alternating first laminate members 20 and second laminate members 22. One of the first laminate members 20 is shown in FIGS. 5 and 7 and is formed of a thin sheet of metal having a thickness preferably from 0.030″ to 0.004″ (0.70 mm to 0.10 mm). The first laminate member 20 is preferably arcuate in shape and preferably has a contiguous planar bottom surface 38. A recess 40 is preferably chemical etched into the first laminate member 20 from its top surface 42. The recess 40 has a depth that is preferably at least half, and more preferably 70%, the thickness of the first laminate member 20 and extends from the first laminate member's outer radial edge 44 to its inner radial edge 46. A plurality of pass-through passageways 48 extend through the first laminate member 20 from the top surface 42 of the first laminate member to its bottom surface 38. The recess 40 is spaced from the pass-through passageways 48 in a manner such that the pass-through passageways are completely bound by material from the top surface 42 to the bottom surface 38 of the first laminate member 20. A first set 50 of the pass-through passageways 48 are circumferential spaced from each other adjacent the outer radial edge 44 of the first laminate member 20. A second set 52 of the pass-through passageways 48 are circumferential spaced from each other adjacent the inner radial edge 46 of the first laminate member 20. The total cross-sectional area of the first set 50 of the pass-through passageways 48 is preferably appreciably greater than the total cross-sectional area of second set 52 of the pass-through passageways. A plurality of diamond shaped protrusions 54 preferably extend vertically through the recess 40 to the top surface 42 of the first laminate member 20 and are spaced relatively uniformly throughout the recess. A plurality of tooling holes 56 also extend vertically through the first laminate member 20.

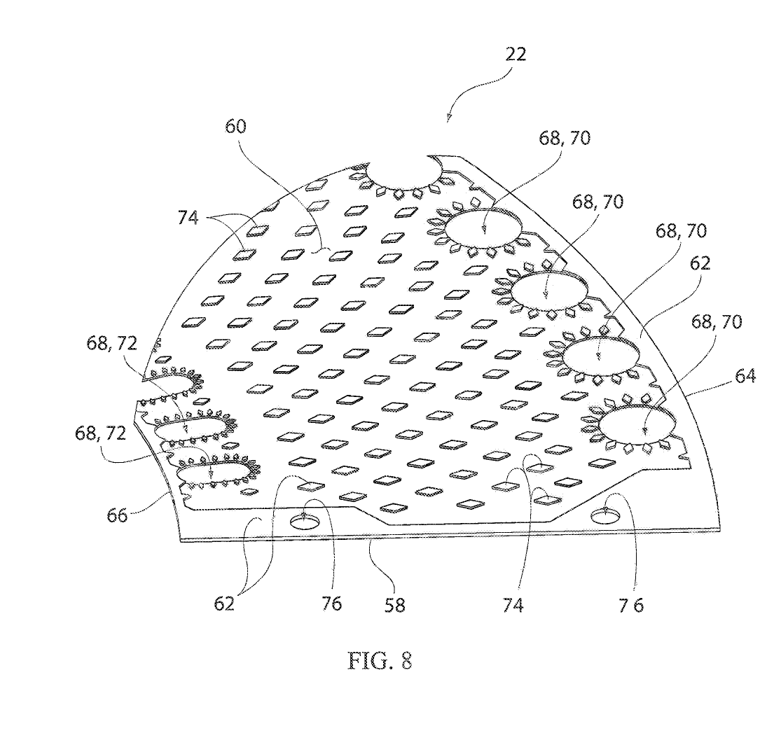

One of the second laminate members 22 is shown in FIGS. 6 and 8. The second laminate member 22 preferably has a thickness and overall dimensions equal to that of the first laminate member 20. Like the first laminate member 20, the bottom surface 58 of the second laminate member is preferably a contiguous planar surface. Additionally, a recess 60 is preferably chemical etched into the second laminate member 22 from its top surface 62. Unlike the recess 40 of the first laminate member 20, the recess 60 of the second laminate member 22 stops short of the outer radial edge 64 and the inner radial edge 66 in a manner such that the entire perimeter of the second laminate member extends from the bottom surface 58 to the top surface 62. A plurality of openings 68 extend through the second laminate member 20 from the bottom surface 58 of the second laminate member and into the recess 60. A first set 70 of the openings 68 are circumferential spaced from each other adjacent the outer radial edge 64 of the second laminate member 22. A second set 72 of the openings 68 are circumferential spaced from each other adjacent the inner radial edge 66 of the second laminate member 22. The total cross-sectional area of the first set 70 of the openings 48 is preferably appreciably greater than the total cross sectional area of second set 72 of the openings. The recess 60 extends from the first set 70 of the openings 68 to the second set of the openings. Like with the first laminate member 20, a plurality of diamond shaped protrusions 74 preferably extend vertically through the recess 60 to the top surface 62 of the second laminate member 22 and are spaced relatively uniformly throughout the recess. A plurality of tooling holes 76 also extend vertically through the first laminate member 20.

As mentioned above, each of the subassemblies 12 of the heat exchanger 10 is preferably assembled using a diffusion bonding technique. Although diffusion bonding can be a complicated process, the use of diffusion bonding renders the subassemblies 12 suitable for high temperature materials such as Nickel based alloys and titanium alloys and reduces the number of steps required to fabricate the subassemblies. Moreover, the inter-metallic bonds formed by diffusion bonding are superior to conventional brazed or welded bonds, reducing fatigue failure.

During the assembly process, the stack 18 of alternating first laminate members 20 and second laminate members 22 is created using one-hundred and sixty of each of the first laminate members and the second laminate members. To ensure that the laminate members are properly aligned with each other, alignment rods can be inserted through the tooling holes 56, 76 of the laminate members. The stack 18 is then sandwiched between the upper end plate 14 and the lower end plate 16 and the assembly is then diffusion bonded to secure the laminate members to each other and to the end plates. The diffusion bonding step bonds the top surface of each of the laminate members to the bottom surface of the laminate member directly above (except for the upper most laminate, which bonds to the bottom surface of the upper plate. The diamond shaped protrusions transfer the axial compressive load generated during the diffusion bonding process from each laminate member to the next, ensuring that the entire top surface of each laminate becomes bonded.

As assembled, the pass-through passageways 48 of the first laminate members 20 and the openings 68 of the second laminate members 22 form axial fluid passageways that extend from the top of the stack 18 to the bottom of the stack. These axial fluid passageways connect the recesses 60 of the second laminate members 22 in parallel. The fluid passageway openings 30 of the upper end plate 14 are aligned with the axial fluid passageways that are adjacent the inner radial edges 46, 66 of the first and second laminate members 20, 22. Similarly, the fluid passageway openings 30 of the lower end plate 16 are aligned with the axial fluid passageways that are adjacent the outer radial edges 44, 64 of the first and second laminate members 20, 22. The recesses 40 of the first laminate members 20 allow fluid to pass radially through the stack 18 of laminate members, without directly communicating with fluid in the recesses 60 of the second laminate members 22 or the fluid in the pass-through passageways 48 of the first laminate members.

It should be appreciated that the heat exchanger 10 is well suited for exchanging heat between two gaseous fluid streams. More particularly, the heat exchanger 10 is configured and adapted to serve as a recuperator for recovering heat energy from a stream of combustion exhaust gas and transferring such energy to a stream of combustion intake gas. In use, exhaust gas travels radially inward through the heat exchanger 10 from the region of space around the heat exchanger via the recesses 40 of the first laminate members 20 and is expelled into the region of space encircled by the heat exchanger. Simultaneously, intake gas is preferably drawn into the fluid passageway openings 30 of the upper end plate 14 and out the fluid passageway openings 30 of the lower end plate 16. As it does this, the intake gas is channeled radially outward through the recesses 60 of the second laminate members 22 from the axial fluid passageways adjacent the inner radial edges 46, 66 of the first and second laminate members 20, 22 and to the axial fluid passageways that are adjacent the outer radial edges 44, 64 of the first and second laminate members.

Due to the arcuate shape of the fluid passageways created by the recesses 40, 60 of the first and second laminate members 20, 22, the fluid passageways through which the exhaust gas travels narrow in cross-sectional area and the fluid passageways through which the intake gas travels expand in cross-sectional area. The narrowing of the fluid passageways through which the exhaust gas passes prevents the temperature of the exhaust gas from dropping as much as it would if the passageways maintained a constant cross-sectional area. Similarly, the expansion of the fluid passageways through which the intake gas passes prevents the temperature of the intake gas from increasing as much as it would if the passageways maintained a constant cross-sectional area. This increases the temperature differential between the exhaust gas and the intake gas throughout the heat exchanger and therefore increases the heat conducted through the laminate members from the exhaust gas to the intake gas. As a result, the stagnation temperature of the exhaust gas is actually reduced more than it otherwise would have reduced and the stagnation temperature of intake gas is increased beyond what it otherwise would have increased.

As the fluids pass through the heat exchanger, the diamond shaped protrusions provide tie the laminations to each other in a manner preventing appreciable material deformation that could otherwise result from pressure differences between the two fluids. The diamond shaped protrusions also improve the flow direction and mixing of each of fluid stream. Still further, the diamond shaped protrusions increase heat transfer coefficient by disrupting the laminar flow, which creates regions having undeveloped velocity profiles.

In view of the forgoing, it should be appreciated that the heat exchanger of the present invention provides a large amount of surface area for heat conduction per unit volume of the heat exchanger. Moreover, it should be appreciated that the heat exchanger of the present invention is highly efficient at transferring heat between two gaseous (i.e., compressible) fluid streams. Still further is should be appreciated that the method of manufacturing the heat exchanger is relatively simplistic and strait forward.

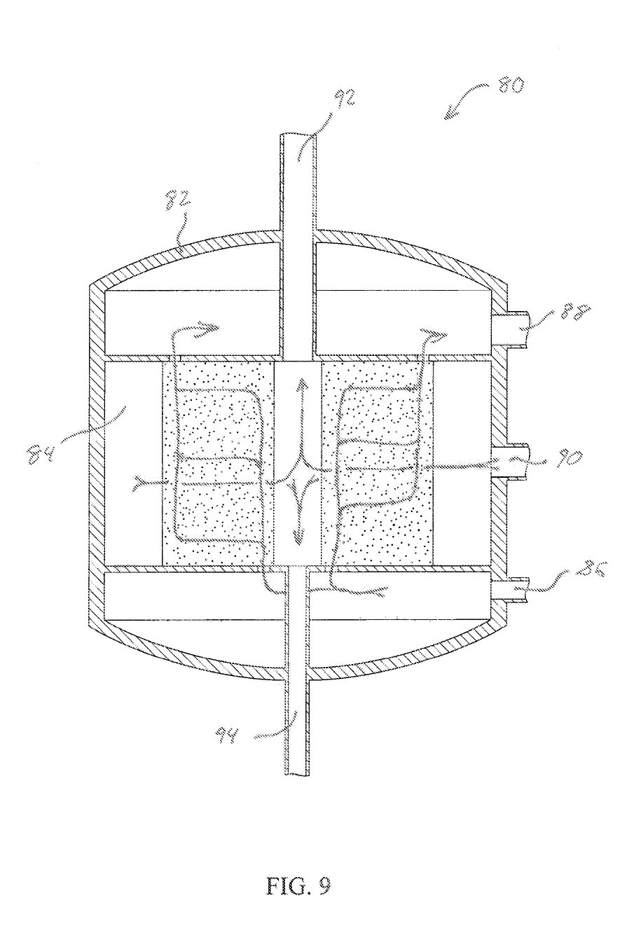

FIG. 9 depicts a assembly 80 comprising the above-described heat exchanger 10. The assembly 80 comprises a housing 82 having an internal cavity 84 in which the heat exchanger 10 is positioned. As shown in FIG. 9, the heat exchanger 10 is inverted such that its lower end plate 16 is oriented beneath its upper end plate 14. The housing 82 of the assembly 80 comprises a cooling fluid inlet 86, a cooling fluid outlet 88, a hot fluid inlet 90, a hot fluid outlet 92, and a condensed fluid outlet 94. The cooling fluid inlet 86 is in direct fluid communication with a portion of the internal cavity 84 of the housing 82 that lies beneath the heat exchanger 10. Similarly, the cooling fluid outlet 88 is in direct fluid communication with a portion of the internal cavity 84 that lies above the heat exchanger 10. These portions of the internal cavity 84 are also in communication with each other through the heat exchanger 10 via the fluid passageway openings 30 of the heat exchanger's end plates 14, 16. The hot fluid inlet 90 is in direct fluid communication with an annular portion of the internal cavity 84 that encircles the heat exchanger 10. This anular portion of the internal cavity 84 is isolated from the above mentioned portions of the internal cavity. However, fluid can pass radially into the region of space encircled by the heat exchanger 10 by passing through the recesses 40 of the first laminate members 20. The region of space encircled by the heat exchanger 10 is also in direct fluid communication with the hot fluid outlet 92 and the condensed fluid outlet 94.

The assembly 80 just described is particularly well suited for use in connection with fuel cells and more particularly for separating steam for hydrogen as a mix of the same is cooled via the heat exchanger 10. This is done by passing vaporized steam and hydrogen mixture into the assembly 80 via the hot fluid inlet 90, while simultaneously passing cooler air or another cooler fluid into the assembly via the cooling fluid inlet 86 and out of the cooling fluid outlet 88. The vaporized steam and hydrogen mixture is thereby cooled as it passes through the heat exchanger 10 and into the region of space encircled by the heat exchanger. The cooling of the vaporized steam and hydrogen mixture causes the steam to condense and thereafter gravity causes the lighter hydrogen to move upward and out of the assembly via the hot fluid outlet 92, and causes the heavier liquid water to travel downward and out of the assembly via the condensed fluid outlet 94.

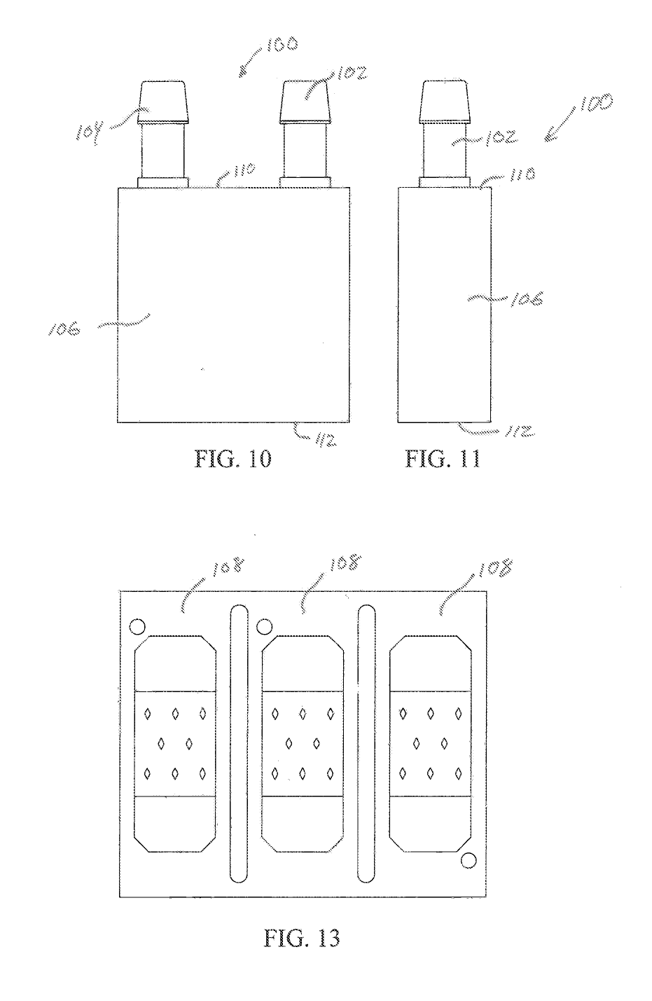

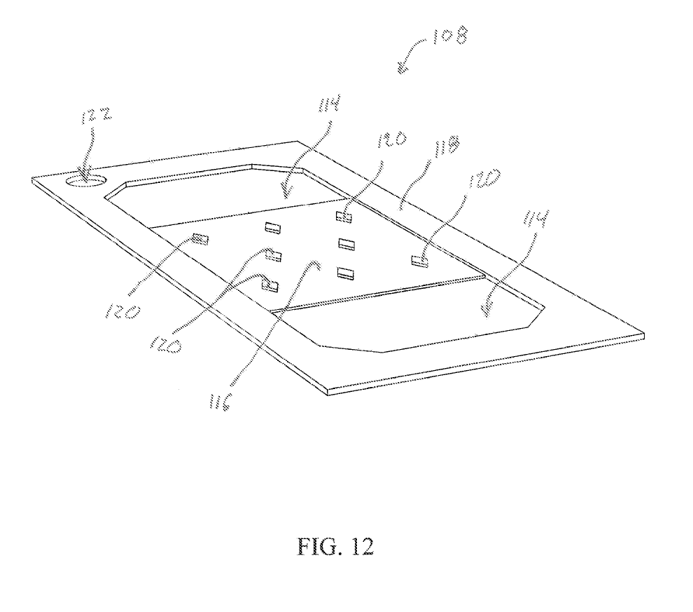

Another embodiment of the invention is shown in FIG. 10 and is configured as an internally cooled heatsink 100. Unlike the heat exchanger 10 described above, the heatsink 100 is configured to absorb heat through conduction from other objects, such as insulated gate bipolar transistors or central processing units. As such, the heatsink needs only comprise a single fluid inlet 102 and single fluid outlet 104. The main body 106 of the heatsink 100 preferably comprises a stack of identical laminates 108 that are sandwiched between an upper end plate 110 and lower end plate 112. As shown in FIG. 12, each laminate 108 comprises two fluid channel through-holes 114 that extend through the thickness of the laminate. An etched region 116 extends down into the laminate 108 from the top surface 118 of the laminate. The etched region 116 preferably extends approximately half way through the thickness of the laminate 108 and provides a fluid connection between the two fluid channel through-holes 114. A plurality of diamond shaped protrusions 120 protrude upward from the bottom half of the laminate 108 all the way to the top surface 118. One or more tooling holes 122 may also optionally extend through the thickness of the laminate 108. The diamond shape protrusions 120 and the tooling holes 122 serve the same purpose as those of the first heat exchanger 10 described above. When stacked and diffusion bonded together, the fluid channel through-holes 114 of the laminates 108 from two fluid channels that extend vertically through the stack of laminates and the etched regions 116 or the laminates operatively connect the said fluid channels in parallel. The lower end plate 112 caps the openings of the stack of laminates and the upper end plate operatively connects one of the two fluid channels to the fluid inlet 102 and the other to the fluid outlet 104.

During the assembly of the heatsink 100, a plurality of identical heatsinks are preferably from together. As shown in FIG. 13, multiple lamentations 108 can be formed and etched as a single part. Likewise, multiple endplates 110, 112 can be formed as a single part. After diffusion bonding the laminates and endplates together, the opposite faces of the stack can be milled down to separate the heatsinks from each other.

In use, cooling fluid is passed into the fluid inlet 102. The cooling fluid then travels through the etched regions 116 of the laminates 108 and subsequently out of the fluid outlet 104. As such, heat conducted into the main body 106 of the heat sink 100 from an object being cooled is conducted and/or radiated into the cooling fluid and out of the heat sink.

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

It should also be understood that when introducing elements of the present invention in the claims or in the above description of the preferred embodiment of the invention, the terms “comprising,” “including,” and “having” are intended to be open-ended and mean that there may be additional elements other than the listed elements. Additionally, the term “portion” should be construed as meaning some or all of the item or element that it qualifies. Moreover, use of identifiers such as first, second, and third should not be construed in a manner imposing any relative position or time sequence between limitations. Still further, the order in which the steps of any method claim that follows are presented should not be construed in a manner limiting the order in which such steps must be performed.

What is claimed is:

1. A method of transferring heat from a warmer stream of gas to a cooler stream of gas, the method comprising:
flowing the warmer stream of gas through a heat exchanger in a manner such that the warmer stream of gas converges as the warmer stream of gas flows through the heat exchanger and in a manner such that the warmer stream of gas is at least partially bound by a wall of the heat exchanger;
flowing the cooler stream of gas through the heat exchanger in a manner such that the cooler stream of gas diverges as the cooler stream of gas flows through the heat exchanger and in a manner such that the cooler stream of gas is at least partially bound by the wall of the heat exchanger; and
allowing heat to conduct through the wall from the warmer stream of gas to the cooler stream of gas through the heat exchanger.

2. A method in accordance with claim 1 wherein the steps of flowing the warmer stream of gas through the heat exchanger and flowing the cooler stream of gas through the heat exchanger occur in a manner such that the warmer stream of gas and the cooler stream of gas flow along opposite sides of the wall of the heat exchanger in opposite directions.

3. A method in accordance with claim 1 wherein the heat exchanger has a generally cylindrical exterior and encircles a concentric generally cylindrical interior gas chamber, the heat exchanger is encircled by an exterior gas chamber, the heat exchanger comprises a plurality of first gas passageways that extend radially through the heat exchanger and that operatively connect the interior and exterior gas chambers, and the step of flowing the warmer stream of gas through the heat exchanger occurs in a manner such that the warmer stream of gas flows from the exterior gas chamber to the interior gas chamber via the first gas passageways.

4. A method in accordance with claim 3 wherein the heat exchanger comprises at least one axially oriented second passageway, at least one axially oriented fourth passageways, and a plurality of radially oriented fourth gas passageways, the third gas passageway is radially further from the interior gas chamber than is the second gas passageway, the fourth gas passageways are connected in parallel by the second and third gas passageways, the second, third, and fourth gas passageways are isolated from the exterior gas chamber, the interior gas chamber, and the first gas passageways, and the step of flowing the cooler stream of gas through the heat exchanger occurs in a manner such that the cooler stream of gas flows from the second gas passageway and into the third gas passageway via the fourth gas passageways.

5. A method in accordance with claim 4 wherein the step of flowing the cooler stream of gas through the heat exchanger occurs in a manner such that the cooler stream of gas flows within the second gas passageway in a direction axially opposite to the direction that the cooler stream of gas flows within the third gas passageway.

6. A method in accordance with claim 4 wherein the first gas passageways and the fourth gas passageways are arranged in an alternating manner such that each of the first gas passageways lies axially between two of the fourth gas passageways.

7. A method in accordance with claim 6 wherein the step of flowing the cooler stream of gas through the heat exchanger occurs in a manner such that the cooler stream of gas flows within the second gas passageway in a direction axially opposite to the direction that the cooler stream of gas flows within the third gas passageway.

8. A method in accordance with claim 1 wherein the heat exchanger comprises first and second fluid outlets and the warmer stream of gas comprises a mixture of a first and second gases when the warmer stream of gas is introduced into the heat exchanger, the step of allowing heat to conduct through the wall from the warmer stream of gas to the cooler stream of gas through the heat exchanger causes at least some of the first gas to condense to a liquid, and the method further comprises using gravity to separate at least some of the liquid from the mixture in a manner converting the mixture into first and second fluid streams, discharging the first fluid stream from the heat exchanger via the first fluid outlet, and discharging the second fluid stream from the heat exchanger via the second fluid outlet.

9. A heat exchanger that extends at least partially around and along a central axis, the central axis defining axial and radial directions, the heat exchanger at least partially encircling an interior fluid containing region and being at least partial encircled by an exterior fluid containing region, the heat exchanger comprising a plurality of arcuate fluid passageways alternating in the axial direction with a plurality of arcuate fluid cavities, each of the arcuate fluid passageways extending radially through the heat exchanger and creating a fluid connection between the interior and exterior fluid containing regions, the heat exchanger also comprising first and second axially extending fluid passageways that traverse each of the arcuate fluid passageways and are in fluid communication with each of the arcuate fluid cavities in a manner connecting the arcuate fluid cavities in parallel, the first axially extending fluid passageway being a first radial distance from the central axis and the second axially extending fluid passageway being a second radial distance from the central axis, the second radial distance being greater than the first radial distance.

10. A heat exchanger in accordance with claim 9 wherein each of the arcuate fluid cavities diverges as it extends in a direction radially away from the central axis, and each of the arcuate fluid passageways converges as it extends in a direction radially toward the central axis.

11. A heat exchanger in accordance with claim 10 wherein each of the first and second axially extending fluid passageways has a cross-sectional area perpendicular to the central axis as such axially extending fluid passageway traverses the arcuate fluid passageways, and the cross-sectional area of the second axially extending fluid passageway is greater than the cross-sectional area of the first axially extending fluid passageway.

12. A heat exchanger in accordance with claim 11 wherein the heat exchanger comprises axially opposite first and second end plates, the arcuate fluid passageways and the arcuate fluid cavities are axially between the first and second end plates, the first end plate forms a terminal end of the first axially extending fluid passageway, the second end plate forms a terminal end of the second axially extending fluid passageway, the second axially extending fluid passageway extends through the first end plate, and the first axially extending fluid passageway extends through the second end plate.

13. A heat exchanger in accordance with claim 9 wherein the heat exchanger is annular.

14. A heat exchanger in accordance with claim 9 wherein each of the arcuate fluid passageways is formed by a first laminate member, the first laminate members are substantially identical to each other, each of the arcuate fluid cavities is formed by a second laminate member, the second laminate members are substantially identical to each other, the first and second laminate members are joined in an alternating manner forming an axially oriented stack of the first and second laminate members.

15. A heat exchanger in accordance with claim 14 wherein each of the first laminate members comprises a bottom surface, a top surface, at least two pass-through passageways, and at least one recess, the recess of each of the plurality first laminate members extends down into such first laminate member from the top surface and extends from an edge of such first laminate member to an opposite edge of such first laminate member, each of the pass-through passageways extends through such first laminate member from the top surface to the bottom surface of such first laminate member, each of the second laminate members comprising a bottom surface, a top surface, at least two openings, and at least one recess, the recess of each of the second laminate members extends down into such second laminate member from the top surface of such second laminate member, each of the openings of each of the second laminate members extends from the bottom surface and opens into the recess of such second laminate member in a manner such that said recess operatively joins said openings, each of the pass-through passageways of each of the first laminate members operative connects at least one of the openings of an adjacent one of the second laminate members to at least one of the openings of another adjacent one of the second laminate members.

16. A heat exchanger in accordance with claim 9 wherein the heat exchanger comprises first and second fluid outlets that are in fluid communication with the arcuate fluid passageways via the interior fluid containing region.

17. A method of fabricating a heat exchanger, the method comprising:
solid state welding a plurality of substantially identical first laminate members to a plurality of substantially identical second laminate members in a manner creating a bonded stack of the first and second laminate members comprised of alternating first and second laminate members, each of the first laminate members comprising a bottom surface, a top surface, at least two pass-through passageways, and at least one recess, the recess of each of the plurality first laminate members extends down into such first laminate member from the top surface and extends from an edge of such first laminate member to an opposite edge of such first laminate member, each of the pass-through passageways extends through such first laminate member from the top surface to the bottom surface of such first laminate member, each of the second laminate members comprising a bottom surface, a top surface, at least two openings, and at least one recess, the recess of each of the second laminate members extends down into such second laminate member from the top surface of such second laminate member, each of the openings of each of the second laminate members extends from the bottom surface and opens into the recess of such second laminate member in a manner such that said recess operatively joins said openings, each of the pass-through passageways of each of the first laminate members operative connects at least one of the openings of an adjacent one of the second laminate members to the recess of another adjacent one of the second laminate members.

18. A method in accordance with claim 17 wherein the solid state welding comprises diffusion welding.

19. A method in accordance with claim 18 wherein the method comprises a step of stacking the first laminate members and the second laminate members in a manner creating an unbonded stack of the first and second laminate members comprised of alternating first and second laminate members, and thereafter performing the step of solid state welding in a manner such that the first laminate members are simultaneously diffusion welded to the second laminate members in a manner creating the bonded stack of the first and second laminate members.

20. A method in accordance with claim 17 further comprising chemically etching the recess of each of the plurality first laminate members into each of the plurality first laminate members and chemically etching the recess of each of the plurality second laminate members into each of the plurality second laminate members.

21. A method in accordance with claim 17 wherein the recess of each of the plurality first laminate members has a vertical cross-sectional area at each of the opposite edges and the cross-sectional area of such recess at one of the opposite edges is greater than the cross-sectional area at the other of the opposite edges.

22. A method in accordance with claim 17 wherein the heat exchanger is formed in a manner such that the heat exchanger is annular.

23. A method of fabricating a heat exchanger, the method comprising:
solid state welding a plurality of substantially identical first laminate members to each other in a manner creating a bonded stack of the laminate members, each of the laminate members comprising a bottom surface, a top surface, at least two openings, and at least one recess, the recess of each of the laminate members extends down into such laminate member from the top surface of such laminate member, each of the openings of each of the laminate members extends from the bottom surface and opens into the recess of such laminate member in a manner such that said recess operatively joins said openings.
